(19) United States
(12) Patent Application Publication
(10) Pub. No.: US 2020/0184548 A1
(43) Pub. Date: Jun. 11, 2020

(54) SYSTEMS AND METHODS FOR LEASING EQUIPMENT OR FACILITIES USING BLOCKCHAIN TECHNOLOGY

(71) Applicant: Honeywell International Inc., Morris Plains, NJ (US)

(72) Inventors: Sujay RAO, Bangalore (IN); Satyanarayan KAR, Bangalore (IN); Lisa Estipona BUTTERS, Phoenix, AZ (US); Keerthi JAYARAJAN, Bangalore (IN); Kamesh PALANI, Bangalore (IN); Koyalkar Raman KISHORE, Hyderabad (IN); S Sourav Kumar, Bangalore (IN); Kariyappa Singadi, Bagalkot (IN)

(73) Assignee: Honeywell International Inc.

(21) Appl. No.: 16/594,519

(22) Filed: Oct. 7, 2019

Related U.S. Application Data
(60) Provisional application No. 62/776,809, filed on Dec. 7, 2018.

(51) Int. Cl. G06Q 30/06; G06Q 50/18

(52) U.S. Cl. CPC G06Q 30/0645; G06Q 50/18

(57) ABSTRACT

A method for leasing equipment or facilities using blockchain technology may include: receiving, through a blockchain network, a request from a lessor device or lessee device to initiate an electronic lease agreement transaction between a lessor and a lessee for a select equipment or facility; verifying an identity of the lessor and the lessee via a digital identity of the lessor and the lessee stored in a blockchain shared ledger to determine if the lessor and lessee are authorized users of the blockchain network; verifying an identity of the equipment or facility via a digital identity of the equipment or facility stored in the blockchain shared ledger; and if the identities of the lessor and lessee and the equipment or facility are verified, electronically executing a smart contract for the lease agreement between the lessor and the lessee, the smart contract including rules for enforcing the lease agreement.

### CROSS-REFERENCE TO RELATED APPLICATION(S)

This application claims the benefit of priority to U.S. Provisional Patent Application No. 62/776,809, filed Dec. 7, 2018, the entirety of which is incorporated by reference herein.

### TECHNICAL FIELD

Various embodiments of the present disclosure relate generally to electronic systems for leasing equipment and/or facilities and, more particularly, to systems and methods for leasing equipment or facilities using blockchain technology.

### BACKGROUND

Leasing equipment and vehicles, such as aircraft, may be complex, time-consuming, and inconsistent across the many organizations that participate in the leasing process. For example, in the aerospace industry, it may take 6-18 months for every aircraft redelivery and it may be very costly for lessors and lessees to undergo a lease transfer transaction. Organizations that participate in the leasing process, such as, for example, financial institutions, lessors, lessees, mechanical repair and overhaul (MRO) centers, or traders of spare parts, may face various challenges within the equipment leasing ecosystem.

Financial institutions may provide the monetary funds to enable leasing companies to acquire equipment assets. Financial institutions may desire to mitigate their risk and exposure appropriately. As such, it is important for lessors to ensure that the proper documentation is kept for the equipment in order to minimize the risk for severe and abnormal devaluation of the equipment. Lessors may be organizations that own the equipment that may be leased. As such, lessors may be primarily concerned with keeping the transferability of their equipment at a very high level. A lessor's ability to turn the equipment around quickly to optimize working capital depends on expedited operations. Additionally, lessors may need to minimize equipment (e.g., aircraft) depreciation and ensure the valuable equipment is maintained to levels specified in a lease contract. Lessees, such as airlines and private aircraft fleet operators, may want to ensure that after the lease is expired, the cost to deliver the equipment or vehicle (e.g., the aircraft) back to the lessor are as low as possible. However, lessees may include a security deposit in reserve/escrow to cover any damages or valuation recoup. Further, lessees may use a logbook to keep a record for the leased equipment to ensure that the leased equipment is well maintained and that the lessee has followed the guidelines set by the lease agreement. However, in today's equipment leasing industry, logbooks are mostly kept as handwritten entries on paper.

MRO centers help keep equipment or vehicles up and running by maintenance checks or one time repairs. Down time of the equipment (e.g., an aircraft) may be costly and MRO centers are critical to not only ensuring parts of the equipment are repaired to standard but also ensuring that the proper documentation is generated and stored. Proper documentation that is accessible gives all authorized parties the ability to view repair or maintenance history on the equipment. Events that show patterns of repeating, such as no fault founds (NFFs) are valuable to identify so that they can be prevented in the future. Spare parts traders may partake in the buying and selling of used equipment (e.g., aerospace equipment). In the spare parts industry, documentation may be very important. For example, in the aerospace leasing industry, quality documentation such as 8130 tags, Form 1, non-incident tag, trace, etc. may provide a higher value for the aerospace equipment to be leased.

Further, proper documentation may not always be kept for leasing equipment or facilities, such as aircraft. Documentation may be inconsistent and equipment (e.g., aircraft parts) tracking and recordkeeping may be difficult. The equipment or facility may have a multitude of physical documents related to the equipment or facility and the documents may be improperly or incompletely generated and stored. Financial backers and lessors may further want to ensure that the equipment or facility asset depreciation is minimized. In the aircraft leasing industry, once the aircraft reaches the end of its life and is dismantled at the serialized component level (i.e., the aircraft parts), a large portion of the value of the aircraft and its components depends on whether quality documentation is available. As such, a consistent recordkeeping and document storage process is needed to ensure the value of the equipment or facility is maintained.

Moreover, leasing contract clause execution is manual, subjective, and tedious. Each lessor may have their own version of a lease agreement with a lessee and lease agreements are currently interpreted and executed manually. For example, a lessor must manually audit the lessee to enforce the contract. Poor contract clause monitoring and execution may also lead to premature devaluation of the equipment or facility. In the aircraft leasing industry, lessees, such as international airlines, may keep records based on local regulatory environments of the country in which the airline is located. However, lessors may want the most stringent rules to be enforced.

Lastly, the deployment of a global, consistent process may require significant resources and labor. In the aerospace industry, for example, the current aircraft leasing ecosystem may not be conducive to becoming a globalized process. Without a pure transactional digital platform that includes documents, organizational verification, and contract execution, the current ecosystem may be growth restrictive.

The present disclosure is directed to overcoming one or more of these above-referenced challenges.

### SUMMARY OF THE DISCLOSURE

In one embodiment, a computer-implemented method for leasing equipment or facilities using blockchain technology is disclosed. The method may include: receiving, by a processor through a blockchain network, a request from a lessor device or lessee device to initiate an electronic lease agreement transaction between a lessor and a lessee for a select equipment or facility; verifying, by the processor, an identity of the lessor and the lessee via a digital identity of the lessor and the lessee stored in a blockchain shared ledger to determine if the lessor and lessee are authorized users of the blockchain network; verifying, by the processor, an identity of the equipment or facility via a digital identity of the equipment or facility stored in the blockchain shared ledger; and if the identities of the lessor and lessee and the equipment or facility are verified, electronically executing a smart contract for the lease agreement between the lessor and the lessee, the smart contract including rules for enforcing the lease agreement.

In another embodiment, a system for leasing equipment or facilities using blockchain technology is disclosed. The system may include: a memory having processor-readable instructions therein; and at least one processor configured to access the memory and execute the processor-readable instructions, which when executed by the processor configures the processor to perform a plurality of functions, including functions for: receiving, by the at least one processor through a blockchain network, a request from a lessor device or lessee device to initiate an electronic lease agreement transaction between a lessor and a lessee for a select equipment or facility; verifying, by the at least one processor, an identity of the lessor and the lessee via a digital identity of the lessor and the lessee stored in a blockchain shared ledger to determine if the lessor and lessee are authorized users of the blockchain network; verifying, by the at least one processor, an identity of the equipment or facility via a digital identity of the equipment or facility stored in the blockchain shared ledger; and if the identities of the lessor and lessee and the equipment or facility are verified, electronically executing a smart contract for the lease agreement between the lessor and the lessee, the smart contract including rules for enforcing the lease agreement

In yet another embodiment, a non-transitory computer-readable medium containing instructions for leasing equipment or facilities using blockchain technology is disclosed. The instructions may include: receiving, by a processor through a blockchain network, a request from a lessor device or lessee device to initiate an electronic lease agreement transaction between a lessor and a lessee for a select equipment or facility; verifying, by the processor, an identity of the lessor and the lessee via a digital identity of the lessor and the lessee stored in a blockchain shared ledger to determine if the lessor and lessee are authorized users of the blockchain network; verifying, by the processor, an identity of the equipment or facility via a digital identity of the equipment or facility stored in the blockchain shared ledger; and if the identities of the lessor and lessee and the equipment or facility are verified, electronically executing a smart contract for the lease agreement between the lessor and the lessee, the smart contract including rules for enforcing the lease agreement.

Additional objects and advantages of the disclosed embodiments will be set forth in the description that follows, and will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute embodiments of this specification, illustrate various exemplary embodiments and together with the description, serve to explain the principles of the disclosed embodiments.

FIG. 1 depicts a block diagram of a system for leasing equipment or facilities using blockchain technology, according to aspects of the disclosure.

FIG. 2 depicts a block diagram of an equipment or facilities leasing blockchain network of the system of FIG. 1.

FIG. 3 depicts an exemplary equipment or facility configuration in a blockchain shared ledger of the system of FIG. 1, according to aspects of the disclosure.

FIG. 4 depicts a block diagram of an exemplary system architecture for an equipment or facilities leasing online platform of the system of FIG. 1.

FIG. 5 depicts a block diagram of an exemplary middleware layer of the system architecture of FIG. 4.

FIG. 6 depicts a flow diagram of an exemplary embodiment of a method for leasing equipment or facilities using blockchain technology.

FIG. 7 depicts an example system that may execute techniques presented herein.

### DETAILED DESCRIPTION

The following embodiments describe systems and methods for leasing equipment or facilities using blockchain technology. As used herein, “equipment” may include products or services traded in primary and secondary marketplaces among organizations. As such, “equipment” may include, for example, aircraft, aerospace parts and components, time-constrained equipment/services such as airport gates and runways, or any other aerospace-related product or service leased among airlines, airports, aircraft, or aerospace OEMs. While the exemplary equipment online marketplace platform of the present disclosure relates to aerospace equipment, “equipment” may also include any type of vehicle (e.g., automobile, boat, ship, spacecraft, etc.), vehicle parts and components, vehicle services, heavy equipment, heavy equipment parts and components, heavy equipment services, computing devices, computing device parts and components, computing device services, or any other products or services traded in primary and secondary marketplaces among organizations. Further, as used herein, “facilities” may include places, amenities, or equipment provided for a particular purpose. As such, “facilities” may include, for example, any type of real property, housing, warehouses, buildings, or amenities (such as oil and gas).

As described above, it is difficult to establish trust and compliance in equipment or facility leasing, such as aircraft leasing, among the various participating organizations of a leasing transaction. Embodiments of the present disclosure provide solutions to these barriers by providing a decentralized blockchain network comprising of participants from the various leasing organizations with different roles. Authorized participants verified by the network may interact and initiate lease transactions for the equipment or facilities using specialized blockchain clients, as described below. The blockchain clients may be operated by users or may be automated through devices. The blockchain may establish trusted, digital identities without manually having to check if a person or organization belongs to the network. Further, identity verification may be performed for the physical equipment or facilities, as well.

Embodiments of the present disclosure may provide for equipment or facilities leasing, such as aircraft leasing, and may include several events in a leasing cycle. Table 1 illustrates an exemplary equipment leasing process using blockchain technology. While Table 1 depicts an aircraft leasing process, it is understood that the leasing process illustrated in Table 1 may include leasing any type of equipment, vehicle, or facility.

TABLE 1
Equipment Leasing Process Using Blockchain Technology

| | Onboard | | | | |
|---|---|---|---|---|---|
| | Equipment to | | Repair & | Lease | |
| | Blockchain | Lease | Maintenance | Ownership | |
| Events | Process | Execution | Checks | Transfer | Dismantlement |
| Participants | Lessor/ | Lessor/ | Lessor/ | Lessor/ | Lessor |
| (Blockchain | Lessee | Lessee | Lessee | Lessee | dismantler |
| Clients) | Acquisition | Acquisition | Maintenance | Inspector | |
| | Manager | Manager | Manager | | |
| Smart | Check for | Check & | C check | C check | Bill of sale |
| Contracts | Authorized | record | Mandatory | Mandatory | on components |
| (Automated | Users | ownership | SB updates, | SB updates, | Quality tag |
| Triggers | Submit the | change | AD, and LLP | AD, LLP | checks |
| and Logs) | digitized or | | trace | trace | |
| | digital records | | | | |
| Data | Nose to tail | Bill of sale | Repair and | Ownership | Bill of sale |
| Collection | scanning/ | data | replacement | transfer | |
| | storing of | Equipment | data | data | |
| | all technical | delivery | Technical | Equipment | Serialized |
| | records for | condition | docs | delivery | component |
| | all parts | data | Service reports | condition | dismantlement data |
| Data | Desktop/mobile | Desktop/mobile | Desktop/mobile | Desktop/mobile | Desktop/mobile |
| Collection | application | application | application | application | application |
| Method | scanning | | device or | | |
| | | | aircraft device | | |

As shown in Table 1, the events may include, for example, onboard equipment or facilities to the blockchain process, lease execution, repair and maintenance checks, lease ownership transfer, and dismantlement. At each event, transactional data is collected and a smart contract may verify the data. Once consensus is reached by endorsing parties (e.g., the organization blockchain nodes) across the decentralized blockchain network, the transactions may be permanently recorded in the blockchain shared ledger.

Onboarding the equipment or facilities to the blockchain process may include lessors, lessees, or acquisition managers. Smart contracts may check for authorized users of the lessor and lessee organizations. The smart contracts may further submit digitized or digital records. Data collection may be performed by scanning and storing the equipment or facilities for all parts of the equipment or facilities. For example, data collection for a leased aircraft may include nose to tail scanning and storing of all technical records for all parts of the aircraft. During the onboarding process, data may be collected via a desktop/mobile application, as further detailed below.

Lease execution may include lessors, lessees, or acquisition managers. Smart contracts may check and record ownership change of the equipment or facility. Bill of sale data and equipment or facility condition data may be collected and stored in the blockchain entry. The bill of sale data and equipment or facility condition data may be collected via a desktop/mobile application.

Repair and maintenance checks may include lessors, lessees, and/or maintenance managers. For aircraft leasing, smart contracts may be used to enforce or check for C checks, mandatory service bulletin (SB) updates, airworthiness directives (AD), and/or life limited part (LLP) trace. Repair and replacement data, technical documents, and service reports may be collected via desktop/mobile applications or a device on the equipment or in the facility (e.g., aircraft data device).

Lease ownership transfer may include lessors, lessees, and a lease inspector. During the ownership change transfer, smart contracts may be used for C checks, mandatory SB updates, AD, and LLP trace. Ownership transfer data and equipment or facility delivery condition data may be collected via desktop/mobile applications.

Dismantlement may include a lessor dismantler. Smart contracts may include bill of sale on the components of the equipment or facility and/or quality tag checks. Bill of sale data and serialized component dismantlement data may be collected via desktop/mobile applications or an equipment online marketplace platform.

The subject matter of the present disclosure will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

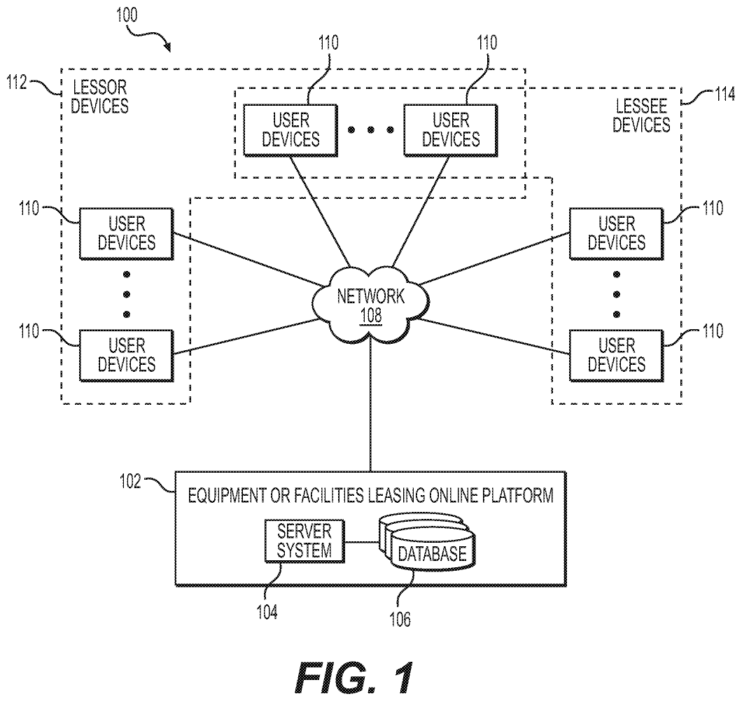

Referring now to the appended drawings, FIG. 1 depicts a block diagram of a system 100 for leasing equipment or facilities using blockchain technology, according to aspects of the disclosure. As shown in FIG. 1, system 100 may include an equipment or facilities leasing online platform 102, such as an aircraft leasing platform, including server systems 104 and shared databases, or ledgers 106. The server systems 104 may store and execute the equipment or facilities leasing online platform 102 for use through a network 108, such as the Internet. The equipment or facilities leasing online platform 102 may be implemented through one or more server systems 104, such as an application program interface (API) server, web page servers, image servers, listing servers, processing servers, search servers, or any other types of front-end or back-end servers.

Users may access the equipment or facilities leasing online platform 102 through the network 108 by user devices 110. User devices 110 may allow a user to display a Web browser for accessing the equipment or facilities leasing online platform 102 from the server system 104 through the network 108. For example, blockchain clients (e.g., users) may connect to the network 108 by user devices 110 for sending data and information to, and receiving data and information from, the equipment or facilities leasing online platform 102. User devices 110 may be any type of device for collecting, storing, sending, and receiving data and information of the equipment or facilities. User devices 110 may include, for example, personal computing devices (e.g., desktop computers), mobile computing devices (e.g., mobile phones), scanners, headsets, cameras, or the like. User devices 110 may further include a secure client API interface, such as an equipment or facilities leasing application, as detailed further below.

User devices 110 may be lessor devices 112 or lessee devices 114. As such, users may be lessors and/or lessees through the equipment or facilities leasing online platform 102. As further shown in FIG. 1, user devices 110 may be both lessor devices 112 and lessee devices 114. Thus, users may access the equipment or facilities leasing online platform 102 as both lessors and lessees. In one embodiment, user devices 110 may include devices other than lessor devices 112 or lessee devices 114. For example, other users (e.g., different users other than lessors and lessees) may access the equipment or facilities leasing online platform 102 via user devices 110. Other users may include, for example, financial institutions, mechanical repair and overhaul (MRO) centers, equipment or facilities inspectors, regulatory bodies (e.g., the Federal Aviation Administration), other government agencies, insurance companies, or any other type of user involved in equipment or facilities leasing transactions.

As discussed above, the equipment or facilities leasing online platform 102 may provide features for a decentralized blockchain network comprising of participants from the various leasing organizations with different roles.

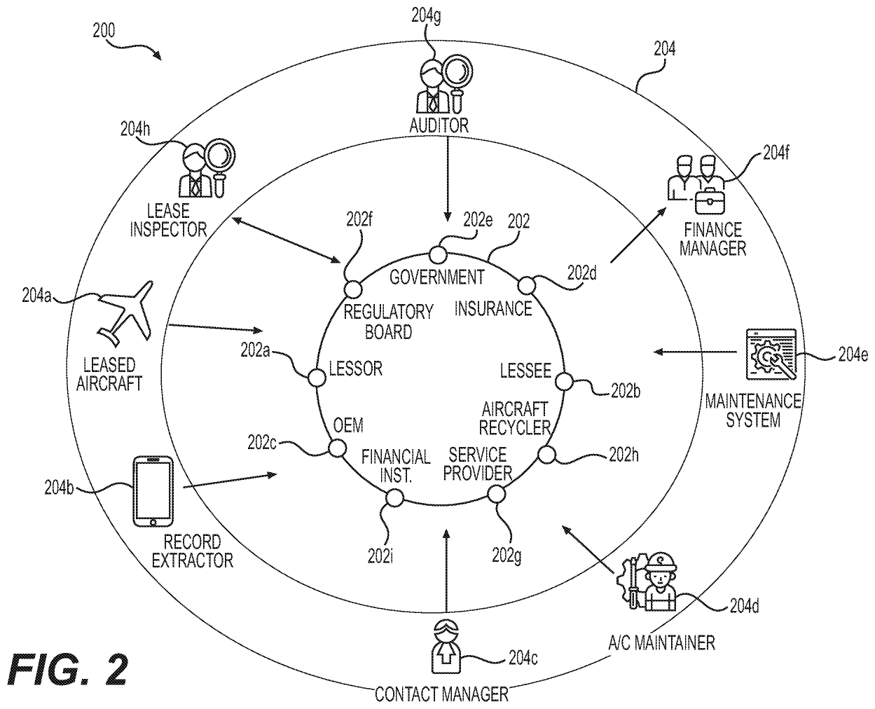

FIG. 2 depicts a block diagram of an equipment or facilities leasing blockchain network 200 of system 100. As shown in FIG. 2, the blockchain network 200 may include organization blockchain nodes 202 and blockchain clients 204. Blockchain nodes 202 may include, for example, lessors 202a, lessees 202b, original equipment manufacturers (OEMs) 202c, insurance organizations 202d, government agencies 202e, regulatory boards 202f, service providers 202g, equipment recyclers (e.g., aircraft recyclers) 202h, and financial institutions 202i. Blockchain clients 204 may include, for example, leased equipment or facilities (e.g., leased aircraft) 204a, record extractors 204b, contract managers 204c, equipment maintainers (e.g., aircraft maintenance organizations or personnel) 204d, maintenance systems 204e, finance managers 204f, auditors 204g, and lease inspectors 204h.

Data and information regarding the lease and leased equipment or facilities may be stored in the blockchain shared ledger 106. The data and information may be received in blockchain shared ledger 106 from the various blockchain clients 204. For example, the leased equipment 204a (e.g., leased aircraft) may collect and send data of the equipment 204a (e.g., aircraft) health to the blockchain shared ledger 106. The record extractors 204b may collect and send data and information relating to onboard legacy records. The contract managers 204c may configure and send a lease contract. The equipment or facilities maintainers 204d may collect, determine, and send maintenance information relating to the equipment or facilities 204a. The maintenance systems 204e may collect and send maintenance/repair reports of the equipment or facilities 204a. The finance manager 204f may determine a value of the equipment or facilities 204a and the organization blockchain nodes 202a-202i may query the finance managers 204f for the value of the equipment or facilities 204a. The auditors 204g may audit the lessor and lessees for compliance of the lease contract. The lease inspectors 204h may monitor and inspect the lease contract. Thus, a blockchain entry including the information received from the blockchain clients 204 may be created in the blockchain shared ledger 106 and updated by the blockchain network 200.

Equipment or facilities leasing online platform 102, using blockchain technology, may establish trusted, digital identities. For example, user identity may be verified digitally through the smart contracts and an inherent consensus model. Further, the blockchain network 200 may be utilized to transform the physical identity of the equipment or facilities (e.g., aircraft, engine, APU, components, etc.) into irrefutable digital identities with clear titles endorsed in the distributed blockchain shared ledger 106, as detailed below.

As described above, mobile devices, web applications, and wireless scanning hardware may be used to capture the data and information. The blockchain network 200 may then validate authenticated users with their authorization levels using the rules stored in the smart contracts. Smart contracts may be cryptographically secure and tamper resistant. Further, the blockchain shared ledger 106 may be accessed by various organizations and users based on security authorizations by the participating organizations.

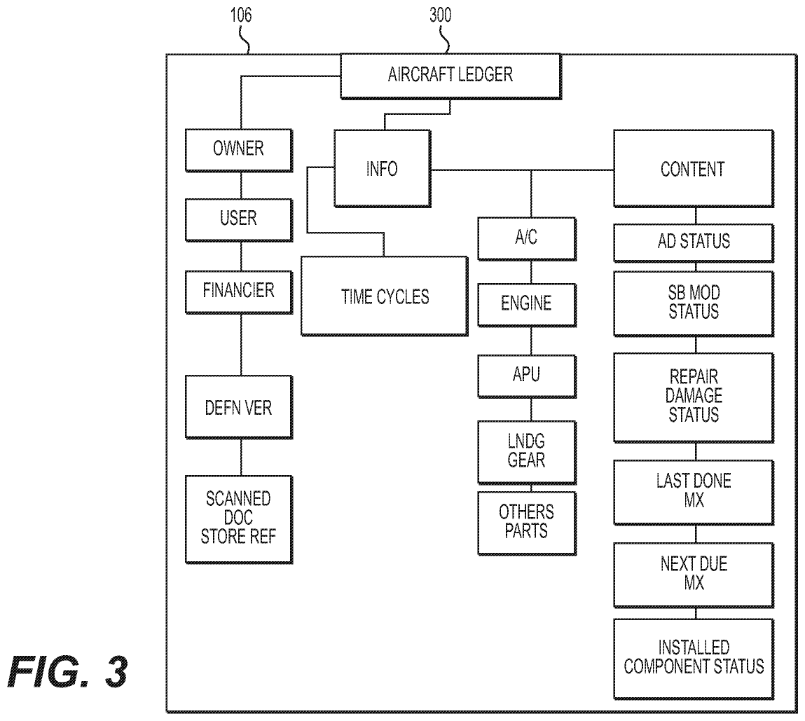

FIG. 3 depicts an exemplary equipment or facility configuration 300 in the blockchain shared ledger 106 of system 100. As shown in FIG. 3, in the exemplary embodiment of aircraft leasing, an aircraft configuration 300 of blockchain shared ledger 106 may include information and data relating to a leased aircraft 204a. The blockchain shared ledger 106 for the equipment or facility 204a may include, for example, information and data relating to ownership of the aircraft, user, financier, equipment or facility definition version, scanned document store reference, and/or equipment or facility information. The equipment or facility information may include, for example, equipment or facility identification information (e.g., aircraft tail number), time cycles of the equipment or facility, and content of the equipment or facility. In the exemplary embodiment of aircraft leasing, the equipment or facility information may further include engine information, APU information, landing gear information, and information of any other parts of the aircraft. Content of the equipment or facility may include, for example, AD status, SB mod status, repair damage status, last done maintenance check, next due maintenance check, installed components status.

The following set of detailed steps may be distributed applications mapped to a lifecycle of the equipment or facility (e.g., the aircraft) which may utilize a smart leasing function. In the exemplary embodiment of aircraft leasing, a new aircraft or an existing aircraft may be onboarded in to a blockchain-based process, as described above. The onboarding process may include traditional aircraft configuration formats which may be provided as a list that details serialized components on the aircraft at the time of delivery. In one embodiment, the list may be provided in untagged formats, such as hard copy (e.g., paper), portable document format (PDF), or spreadsheets. To enable diverse databases and applications to correctly interpret the information and to facilitate a baseline, it may be necessary for the data to be a in a normalized, common format.

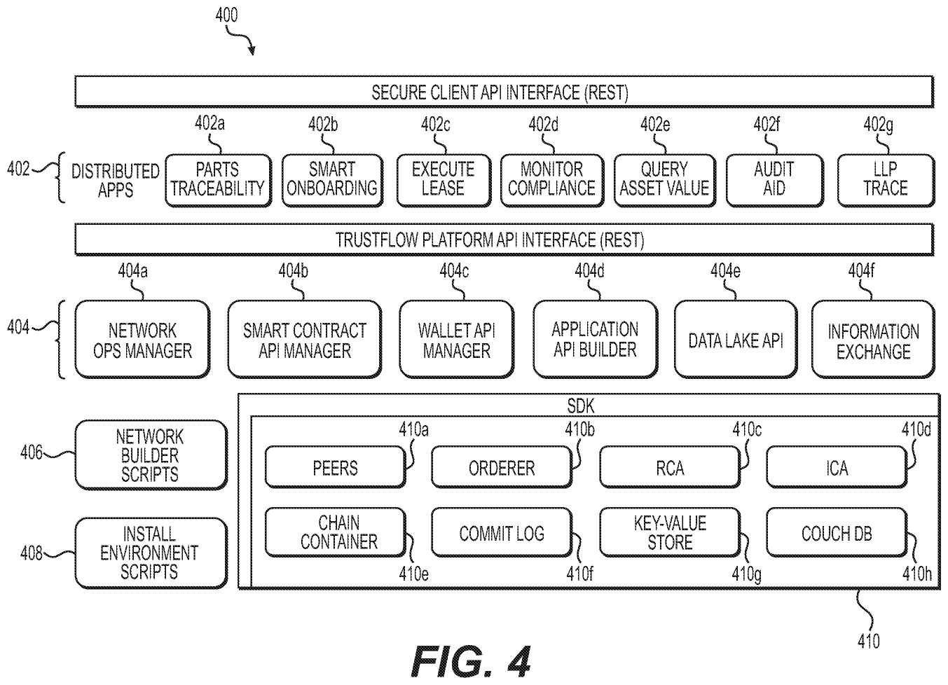

The steps for onboarding the equipment or facility may be performed by a blockchain client via a client application hosted on a mobile phone or a specialized device such as a laptop or scanner, as detailed further below with respect to FIG. 4. The client application may allow the blockchain clients to establish their identity in the equipment or facilities leasing blockchain network.

A first step may include physical to digital upload of all hard copies of documents. For example, any hard copies of the documents may be digitally scanned.

A second step may include automatic extraction of information from the digital documents. Automatic extraction may include extracting information from the digitally scanned documents (e.g., in PDF format) using specialized recognition models, such as optical character recognition (OCR), and transforms the information to a normalized digital format. Similarly, other existing digital format data may be transformed to a normalized digital format. Thus, a digitized configuration of the equipment or facility (e.g., an aircraft) may be stored in the secure document store of blockchain shared ledger 106. Files in the secure document store may be stored in the normalized digital format.

A third step may include verification. For example, the information represented in the digital format may be verified against an approved equipment or facilities configuration model and verified by a certified inspector. Upon successful verification, the normalized equipment or facilities digital configuration 300 may be submitted to the equipment or facilities leasing blockchain network 200. The credential of the inspector performing the role may be verified by the equipment or facilities leasing blockchain network 200 and the transaction may be recorded in the blockchain shared ledger 106.

A fourth step may include creating a searchable database of the equipment or facilities 204a on the equipment or facilities leasing online platform 102. The equipment or facilities 204a may be registered in the blockchain network 200 as an asset registry. All references to the equipment or facilities 204a may be searchable through an equipment or facility identifier, serial number, or any other identifiable information of the equipment or facility 204a.

FIG. 4 depicts a block diagram of an exemplary system architecture 400 for equipment or facilities leasing online platform 102. As shown in FIG. 4, system architecture 400 of platform 102 may include a layered architecture. For example, system architecture 400 may utilize a blockchain framework, such as Hyperledger. As such, system architecture 400 may include a secure client API interface, such as representational state transfer (REST). System architecture 400 may include an application layer 402 that may include one or more distributed applications and/or one or more software modules 402a-402g for leasing equipment or facilities using blockchain technology. The one or more applications and/or one or more software modules 402a-402g may include, for example, parts traceability 402a, smart onboarding 402b, execute lease 402c, monitor compliance 402d, query asset (equipment or facilities) value 402e, audit aid 402f, and life limited part (LLP) trace 402g.

The parts traceability application 402a may allow the blockchain nodes 202 and/or blockchain clients 204 to collect and access a history of the equipment or facility to assist in the leasing process. For example, the blockchain nodes 202 and/or blockchain clients 204 may access and add equipment or facilities pedigree information to the blockchain shared ledger 106 for the equipment or facility. The equipment or facilities pedigree information may track or trace whenever the equipment or facility goes through a specific event. For example, events, such as maintenance events, may generate documents that may be properly stored and accessed on the blockchain shared ledger 106 through the blockchain network 202. In the aircraft leasing industry, the equipment or facilities pedigree information may include an aircraft and/or aircraft parts pedigree. As such, the equipment or facilities pedigree information for an aircraft, for example, may include part, serial number, aircraft, event, product image, quality documents, or the like. Events for an aircraft that may generate documents may include, for example, birth, install, repair, re-install, or death/scrap of a part. The event may be recorded by uploading documents, image, or information via the parts traceability application 402a by a scanning or photo device that may write the document, image, or information to the blockchain shared ledger 106 for each equipment or facility.

The smart onboarding application 402b may facilitate onboarding new users (e.g., blockchain nodes 202 and/or blockchain clients 204) to the equipment or facilities leasing online platform 102. For example, each member organization (e.g., lessee, lessor, MRO, financial institution, etc.) of the equipment or facilities leasing online platform 102 may have a different role on the equipment or facilities leasing online platform 102. Each of the different roles may include different level of rights and/or responsibilities on the equipment or facilities leasing online platform 102. The smart onboarding application 402b may further allow member organizations to manage the roles of individual members of the respective organization.

The execute lease application 402c may include tools to develop a lease contract. For example, the execute lease application 402c may facilitate coordination between the lease participants (e.g., lessors and lessees) and execute (e.g., signing) the lease contract. Server 104 may generate the lease contract via, for example, a smart contract. As used herein, a smart contract is a computer protocol intended to digitally facilitate, verify, or enforce the negotiation or performance of a contract.

The monitor compliance application 402d may allow blockchain nodes 202 and clients 204 to use and enforce the smart contracts via the blockchain network 200. For example, the monitor compliance application 402d may facilitate the monitoring of the contract rules and alert the concerned members if there is deviation from the contract rules. Smart contracts may be interpreted by the blockchain in bits and bytes instead of blockchain clients 204 relying on third parties to enforce the contracts. For example, a smart contract may be used to enforce aircraft maintenance checks. If there is a contract clause in the lease contract that requires the lessee to perform yearly maintenance checks every twelve months, a smart contract may be used to automatically check if the lessee is complying with the contract clause. The blockchain network 200 may perform a digital check (via the monitor lease application 204d) to see if the aircraft tail has the maintenance event loaded based on the contract rules and specified time periods loaded in the smart contract. Further, regulatory rules, such as rules set by the FAA for aircraft, may also be enforced through the smart contract. For example, the smart contract may be loaded against an aircraft tail (or equipment or facility) to set the rules and regulations based on different standards. The automated and digital checks on the blockchain network 200 may notify (e.g., via an alert) both the lessee and the lessor when an aircraft (or equipment or facility) is in violation of the contract.

The query asset value application 402e may provide various estimates of the value associated with the leased equipment or facilities. For example, server 104 may receive a request from a user via the query asset value application 402e for an estimated value of the leased equipment or facility. Server 104 may then send the estimated value to the user via the query asset value application 402e.

The audit aid application 402f may allow users to schedule and conduct various audits associated with the leased equipment or facility (e.g., aircraft). For example, server 104 may provide data access to authorized auditors 204g, track the compliance and deviations, and generate tractability reports via the audit aid application 402f.

The LLP trace application 402g may provide a mechanism to track and trace the life limited parts involved in the lease operations. As used herein, a “life limited part” is any part for which a mandatory replacement limit is specified for the part. For example, leased aircraft 204a may include life limited parts that may be traced via the LLP trace application 402g.

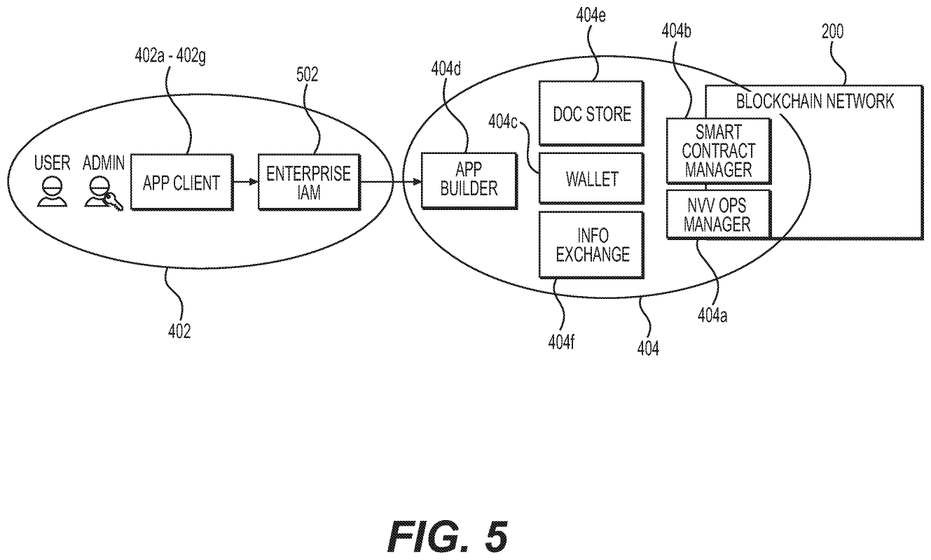

As further shown in FIG. 4, system architecture 400 may further include a middleware layer 404. For example, middleware layer 404 may include a containerized middleware that may allow applications 402a-402g to access and deploy on the blockchain network 200. The middleware layer 404 may include tools to manage the different organizations and their role. The middleware layer 404 may further include tools to manage the smart contracts. The middleware layer 404 may be implemented using a blockchain platform API interface, such as TrustFlow platform API interface using REST. As such, middleware layer 404 may include a network operations manager 404a, a smart contract manager 404b, a wallet manager 404c, an application builder 404d, a doc store/date lake service 404e, and an information exchange 404f, as further detailed below with reference to FIG. 5.

The TrustFlow platform API interface may further include network builder scripts 406, install environment scripts 408, and a software development kit (SDK) 410 including containers 410a-410h, such as Hyperledger Fabric containers. The containers 410a-410h may host the smart contracts that contain the application logic of system architecture 400. The containers 410a-410h may include, for example, peers 410a, orderer 410b, root certificate authorities (RCAs) 410c, intermediate certificate authorities (ICAs) 410d, chain container 410e, commit log 410f, key-value store 410g, and a couch database (DB) 410h. The containers 410a-410h may be distributed across the blockchain network 200.

Peers 410a may host the blockchain shared ledger 106 and the smart contracts created and executed by the blockchain network 200. Peers 410a may enable administrators and applications to interact with the services that they provide. Peers 410a may host one or more ledgers 106 and one or more smart contracts.

Orderer 410b may form and host the ordering services. The ordering services may provide a shared communication channel to nodes 202 and clients 204. For example, orderer 410b may allow clients 204 to connect to the communication channel and broadcast messages on the channel which are then delivered to the nodes 202.

RCAs 410c may include a server and a client component for registration of identities, issuance of enrollment certificates, and/or certificate renewal and revocation.

ICAs 410d may communicate with the RCA 410c to allow for scaling. For example, ICAs 410d may have their certificates issued by RCAs 410c, thus may allow the establishment of a chain of trust for any certificate that may be issued by any certificate authority (RCA and/or ICA) in the chain.

Chain container 410e may allow for isolation of the smart contract's execution from the peers 410a. Executing the smart contract through chain container 410e may prevent the smart contract from crashing or accessing a peer 410a (e.g., a node 202) due to an error or malicious code.

Commit log 410f may be a message handling system, such as Kafka. For example, commit log 410f may include a data structure that only appends such that modification and deletion is not possible. Commit log 410f may allow consumers to subscribe to a topics to receive new messages that may be published by a producer. Commit log 410f may sequentially order all messages inside a respective partition.

Key-value store 410g may be in communication with commit log 410f to store metadata and may handle the mechanics of clustering. Key-value store 410g may be, for example, Fabric Zookeeper. Metadata stored in key-value store 410g may include, for example, a consumer group's offset per partition, access control lists (ACL), producer and consumer quotas, and/or partition leaders and their health.

Couch DB 410h may include an external state database. For example, couch DB 410h may store any binary data that may be modeled in a smart contract.

FIG. 5 depicts a block diagram of an exemplary middleware layer 404 of the system architecture 400. Middleware layer 404 may provide specialized functions, built on a blockchain protocol framework (e.g., Hyperledger), for the development and operation of the applications 402. Middleware layer 404 may be containerized, which may expose a set of APIs, libraries, tools, and user consoles to integrate and manage the application layer 402 over blockchain network 200. As shown in FIG. 5, application layer 402 may be in communication with middleware layer 404 via an enterprise identity and access management (IAM) tool 502. For example, each application 402a-402g may be in communication with IAM tool 502. IAM tool 502 may be in communication with application builder 404d, as detailed below. As discussed above, middleware layer 404 may include various modules, such as a network operations manager 404a, a smart contract manager 404b, a wallet manager 404c, an application builder 404d, a doc store/date lake service 404e, and an information exchange 404f (e.g., an aviation information exchange module).

Network operations manager 404a may facilitate creation and management of blockchain network 200. For example, network operations manager 404a may include tools that allow a network administrator to create application-specific communication channels, join organizational nodes to a respective channel, update channel policy, create and remove organizations on platform 102, and/or monitor network health and other operational parameters.

Smart contract manager 404b may include tools to develop, install, and instantiate application-specific smart contracts (e.g., chaincodes). For example, smart contract manager 404b may include system-specific chaincodes that may facilitate the development of complex workflows with specific participant rules.

Wallet manager 404c may integrate the organization-specific IAM with blockchain participant roles. For example, wallet manager 404c may map the organization user to the blockchain participant role to provide seamless access to blockchain functions to the user. Wallet manager 404c may further store and provide access to the participant certificate to initiate a transaction with blockchain network 200. Wallet manager 404c may include user registration, user revocation, and/or key storage.

Application builder 404d may include tools to develop and manage application-specific APIs. For example, application builder 404d may facilitate interaction between an application 402 and a corresponding channel of blockchain network 200. Additionally, application builder 404d may provide a console for an application administrator to register and set access controls for users on the respective channel.

Doc store/data lake service 404e may provide off chain storage in conjunction with blockchain network 200 for applications 402. Doc store/data lake service 404e may maintain the latest read-only copy of blockchain shared ledger 106, specific to each blockchain node 202, for consumption of applications 402. Doc store/data lake service 404e may also allow user access control specific a document store, as well as access and authorization. Doc store/data lake service 404e may provide a repository for storing digital assets, such as aircraft maintenance logs, flight and/or avionics data, and images, linked to each blockchain transaction.

Information exchange 404f may provide components to build applications 402 compliant to regulation standards. In one embodiment, information exchange 404f for aircraft leasing may provide components to build applications 402 compliant to aviation standards. For example, if a respective application 402 needs to be integrated with Air Transport Association of America (ATA) Spec 200, 2400, 2500, etc., information exchange 404f may facilitate the data format and procedures to be compliant to the ATA Spec and integrate the data format and procedures into the respective application 402.

The network operations manager module may facilitate creation and management of the blockchain network. For example, the server, via the network operations manager module, may create application specific channels, join the organizational nodes to a respective channel, update channel policy, create and remove organizations, and monitor network health and other operational parameters.

The smart contract manager module may provide tools to develop, install, and instantiate application specific smart contracts (e.g., Chaincodes). As used herein, a “chaincode” is a piece of code that may be written in a supported language (e.g., Go or Java) that implements a prescribed interface to initialize and manage ledger (e.g., blockchain) state through transactions submitted through the applications. The smart contract manager module consists of system specific chaincodes to facilitate the development of complex workflows with specific participant roles.

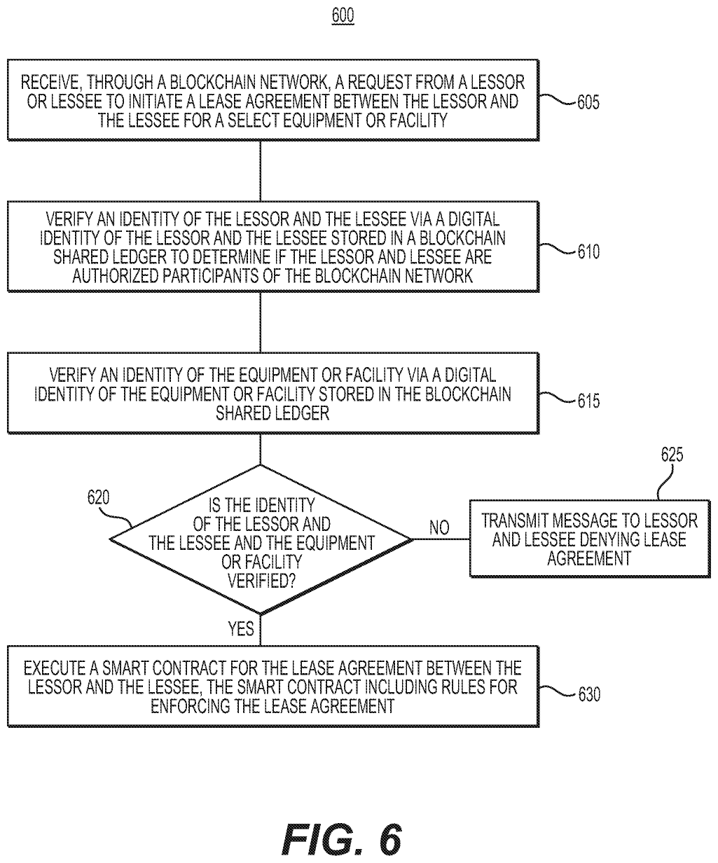

FIG. 6 depicts a flow diagram of an exemplary embodiment of a method for leasing equipment or facilities using blockchain technology. In an initial step 605, a server executing the platform may receive, through the blockchain network, a request from a lessor or lessee to initiate a lease agreement between the lessor and lessee for a select equipment or facility. The server may receive the request from, for example, a lessor device or a lessee device.

In step 610, the server may verify an identity of the lessor and the lessee via a digital identity of the lessor and the lessee stored in a blockchain shared ledger to determine if the lessor and lessee are authorized participants of the blockchain network.

In step 615, the server may verify an identity of the equipment or facility via a digital identity of the equipment or facility stored in the blockchain shared ledger.

In step 620, the server may determine if the identity of the lessor and lessee and the equipment or facility has been verified.

In step 625, if the identity of the lessor, the lessee, or the equipment or facility is not verified, the server may transmit a message to the lessor and the lessee denying the lease agreement.

In step 630, if the identity of the lessor, the lessee, and the equipment or facility are verified, the server may execute a smart contract for the lease agreement between the lessor and lessee. The smart contract may include rules for enforcing the lease agreement.

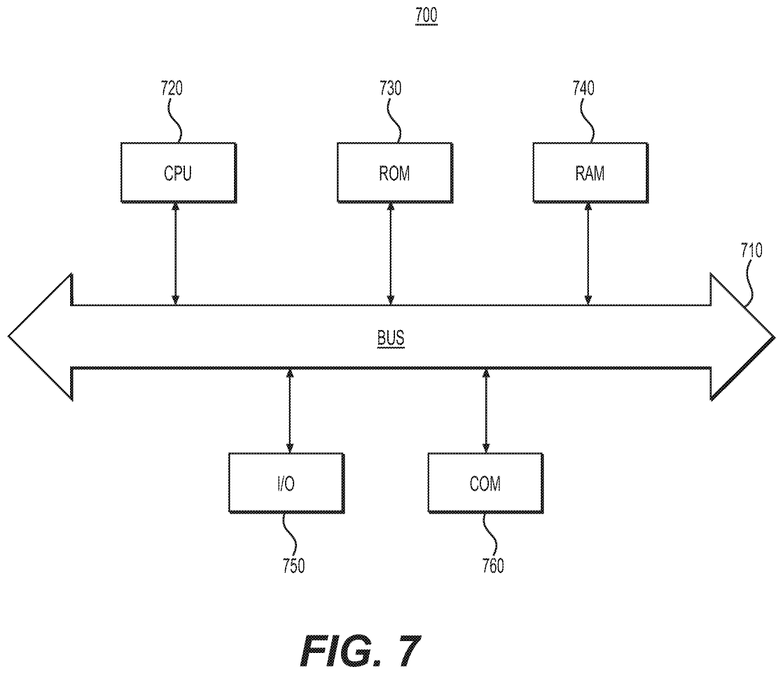

FIG. 7 depicts an example system 700 that may execute techniques presented herein. FIG. 7 is a simplified functional block diagram of a computer that may be configured to execute techniques described herein, according to exemplary embodiments of the present disclosure. Specifically, the computer (or “platform” as it may not a be a single physical computer infrastructure) may include a data communication interface 760 for packet data communication. The platform also may include a central processing unit (“CPU”) 720, in the form of one or more processors, for executing program instructions. The platform may include an internal communication bus 710, and the platform also may include a program storage and/or a data storage for various data files to be processed and/or communicated by the platform such as ROM 730 and RAM 440, although the system 700 may receive programming and data via network communications. The system 700 also may include input and output ports 750 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Other embodiments of the disclosure will be apparent to those skilled in the art from consideration of the specification and practice of the invention disclosed herein. It is intended that the specification and examples be considered as exemplary only, with a true scope and spirit of the disclosure being indicated by the following claims.

What is claimed is:

1. A computer-implemented method for leasing equipment or facilities using blockchain technology, the method comprising:
receiving, by a processor through a blockchain network, a request from a lessor device or lessee device to initiate an electronic lease agreement transaction between a lessor and a lessee for a select equipment or facility;
verifying, by the processor, an identity of the lessor and the lessee via a digital identity of the lessor and the lessee stored in a blockchain shared ledger to determine if the lessor and lessee are authorized users of the blockchain network;
verifying, by the processor, an identity of the equipment or facility via a digital identity of the equipment or facility stored in the blockchain shared ledger; and
if the identities of the lessor and lessee and the equipment or facility are verified, electronically executing a smart contract for the lease agreement between the lessor and the lessee, the smart contract including rules for enforcing the lease agreement.

2. The method of claim 1, wherein verifying, by the processor, the identity of the lessor and the lessee via the digital identity of the lessor and the lessee includes:
receiving, by the processor, endorsements of the identity of the lessor and lessee from existing authorized users via user devices of the blockchain network;
if the identity of the lessor and lessee is endorsed by a threshold number of existing authorized users, generating, by the processor, the digital identity of the lessor and lessee; and
storing, by the processor, the identity of the lessor and lessee in the blockchain shared ledger as authorized users of the blockchain network.

3. The method of claim 1, further comprising generating, by the processor, the digital identity of the equipment or facility prior to verifying the identity of the equipment or facility, wherein the generating, by the processor, the digital identity of the equipment or facility includes:
receiving, by the processor, digital copies of documents related to the equipment or facility being leased;
automatically extracting, by the processor, information from the received digital copies of the documents related to the equipment or facility being leased;
verifying, by the processor, the information from the received digital copies of the documents against an approved equipment or facilities configuration model; and
if the information from the received digital copies is verified, generating, by the processor, the digital identity of the equipment or facility in the blockchain shared ledger, the digital identity including the verified information from the received digital copies.

4. The method of claim 3, wherein verifying, by the processor, the identity of the equipment or facility via the digital identity of the equipment or facility includes:
receiving, by the processor, endorsements of the identity of the equipment or facility from users via user devices on the blockchain network;
if the identity of the equipment or facility is endorsed by a threshold number of users, verifying, by the processor, the identity of the equipment or facility; and
storing, by the processor, the identity of the equipment or facility in the blockchain shared ledger.

5. The method of claim 4, wherein generating the digital identity further comprises:
generating, by the processor, a searchable database of the equipment or facility on the equipment or facilities leasing online platform, the searchable databased including the verified information of the equipment or facility.

6. The method of claim 5, further comprising:
updating, by the processor, the digital identity of the equipment or facility when new information is received and verified.

7. The method of claim 6, further comprising:
monitoring, by the processor, adherence to rules of the smart contract for the lease agreement based on the updated digital identity.

8. The method of claim 7, wherein monitoring, by the processor, adherence to rules of the smart contract for the lease agreement includes:
receiving, by the processor, the updated digital identity;
comparing, by the processor, the information in the updated digital identity with the rules of the smart contract for the lease agreement to see if a condition of the rules has been violated;
if a condition of the rules has been violated, sending an alert to at least one of the lessor or lessee indicating the condition has been violated.

9. The method of claim 1, wherein the digital identity of the equipment or facility includes at least one of identification information of the equipment or facility, time cycle information of the equipment or facility, or content of the equipment or facility.

10. The method of claim 1, wherein the equipment or facility includes an aircraft.

11. A system for leasing equipment or facilities using blockchain technology, comprising:
a memory having processor-readable instructions therein; and
at least one processor configured to access the memory and execute the processor-readable instructions, which when executed by the processor configures the processor to perform a plurality of functions, including functions for:
receiving, by the at least one processor through a blockchain network, a request from a lessor device or lessee device to initiate an electronic lease agreement transaction between a lessor and a lessee for a select equipment or facility;
verifying, by the at least one processor, an identity of the lessor and the lessee via a digital identity of the lessor and the lessee stored in a blockchain shared ledger to determine if the lessor and lessee are authorized users of the blockchain network;
verifying, by the at least one processor, an identity of the equipment or facility via a digital identity of the equipment or facility stored in the blockchain shared ledger; and
if the identities of the lessor and lessee and the equipment or facility are verified, electronically executing a smart contract for the lease agreement between the lessor and the lessee, the smart contract including rules for enforcing the lease agreement.

12. The system of claim 11, wherein verifying, by the at least one processor, the identity of the lessor and the lessee via the digital identity of the lessor and the lessee includes:
receiving, by the at least one processor, endorsements of the identity of the lessor and lessee from existing authorized users via user devices on the blockchain network;
if the identity of the lessor and lessee is endorsed by a threshold number of existing authorized users, generating, by the at least one processor, the digital identity of the lessor and lessee; and
storing, by the at least one processor, the identity of the lessor and lessee in the blockchain shared ledger as authorized users of the blockchain network.

13. The system of claim 11, further comprising generating, by the at least one processor, the digital identity of the equipment or facility prior to verifying the identity of the equipment or facility, wherein the generating, by the at least one processor, the digital identity of the equipment or facility includes:
receiving, by the at least one processor, digital copies of documents related to the equipment or facility being leased via user devices;
automatically extracting, by the at least one processor, information from the received digital copies of the documents related to the equipment or facility being leased;
verifying, by the at least one processor, the information from the received digital copies of the documents against an approved equipment or facilities configuration model; and
if the information from the received digital copies is verified, generating, by the at least one processor, the digital identity of the equipment or facility in the blockchain shared ledger, the digital identity including the verified information from the received digital copies.

14. The system of claim 13, wherein verifying, by the at least one processor, the identity of the equipment or facility via the digital identity of the equipment or facility includes:
receiving, by the at least one processor, endorsements of the identity of the equipment or facility from users via user devices on the blockchain network;
if the identity of the equipment or facility is endorsed by a threshold number of users, verifying, by the at least one processor, the identity of the equipment or facility; and
storing, by the at least one processor, the identity of the equipment or facility in the blockchain shared ledger.

15. The system of claim 14, wherein generating the digital identity further comprises:
generating, by the at least one processor, a searchable database of the equipment or facility on the equipment or facilities leasing online platform, the searchable databased including the verified information of the equipment or facility.

16. The system of claim 15, further comprising:
updating, by the at least one processor, the digital identity of the equipment or facility when new information is received and verified.

17. The system of claim 16, further comprising:
monitoring, by the at least one processor, adherence to rules of the smart contract for the lease agreement based on the updated digital identity.

18. The system of claim 17, wherein monitoring, by the at least one processor, adherence to rules of the smart contract for the lease agreement includes:
receiving, by the at least one processor, the updated digital identity;
comparing, by the at least one processor, the information in the updated digital identity with the rules of the smart contract for the lease agreement to see if a condition of the rules has been violated;
if a condition of the rules has been violated, sending an alert to at least one of the lessor or lessee indicating the condition has been violated.

19. The system of claim 11, wherein the digital identity of the equipment or facility includes at least one of identification information of the equipment or facility, time cycle information of the equipment or facility, or content of the equipment or facility.

20. A non-transitory computer-readable medium containing instructions for leasing equipment or facilities using blockchain technology, comprising:
receiving, by a processor through a blockchain network, a request from a lessor device or lessee device to initiate an electronic lease agreement transaction between a lessor and a lessee for a select equipment or facility;
verifying, by the processor, an identity of the lessor and the lessee via a digital identity of the lessor and the lessee stored in a blockchain shared ledger to determine if the lessor and lessee are authorized users of the blockchain network;
verifying, by the processor, an identity of the equipment or facility via a digital identity of the equipment or facility stored in the blockchain shared ledger; and
if the identities of the lessor and lessee and the equipment or facility are verified, electronically executing a smart contract for the lease agreement between the lessor and the lessee, the smart contract including rules for enforcing the lease agreement.
